(19) United States
(12) Patent Application Publication
(10) Pub. No.: US 2012/0257666 A1
(43) Pub. Date: Oct. 11, 2012

(54) METHOD FOR DETERMINING NOTCHING PARAMETERS IN A PLC SYSTEM AND PLC SYSTEM

(75) Inventor: Markus Rindchen, Osthofen (DE)

(73) Assignee: POWER PLUS COMMUNICATIONS AG, Mannheim (DE)

(21) Appl. No.: 13/517,915

(22) PCT Filed: Dec. 23, 2010
(86) PCT No.: PCT/DE2010/001510

§ 371 Date: Jun. 20, 2012

(30) Foreign Application Priority Data
Dec. 23, 2009 (DE) 10 2009 060 502.9
Jul. 21, 2010 (DE) 10 2010 031 863.9

(51) Int. Cl. H04B 3/54; H04B 3/46

(52) U.S. Cl. 375/227; 375/224

(57) ABSTRACT

A method for determining notching parameters for a PLC (Power Line Communication) Signal in a PLC system, where, by notching in a targeted fashion, frequency ranges are omitted in the PLC signal and the notching parameters are selected such that any interference of the PLC signal with a radio signal is largely avoided, is characterized with regards to the determination of notching parameters even during operation of the PLC system such that, at least for a section of the PLC signals, a signal-interference ratio (SIR) is formed which, depending on the SIR, assesses the signal strength of a radio signal and, based on the assessment notching parameters, are determined or adjusted. A respective PLC system is provided.

### CROSS REFERENCE TO RELATED APPLICATIONS

This application is a national stage application, filed under 35 U.S.C. §371, of International Application No. PCT/DE2010/001510, filed Dec. 23, 2010, which claims priority to German Application Nos. 10 2009 060 502.9, filed Dec. 23, 2009 and 10 2010 031 863.9, filed Jul. 21, 2010, all of which are hereby incorporated by reference in their entirety.

### BACKGROUND

1. Technical Field

The invention relates to a method for determining notching parameters for a PLC (Powerline Communication) signal in a PLC system, with said notching omitting frequency ranges in the PLC signal in a targeted fashion and with the notching parameters being selected such that any interference of the PLC signals with a radio signal is largely avoided.

The invention further relates to a PLC system with a configuration unit to determine notching parameters, where at least one hub of the PLC system can be influenced by the notching parameters such that, in a targeted fashion, frequency ranges are omitted in the PLC signal transmitted via the hub in order to avoid interference of the PLC signal transmitted by the hub with a radio signal.

In BPL (Broadband Power Line) communication data is transmitted via the common power supply network. This is used particularly in buildings; however, it may also be used to provide the “last mile”, i.e. the connection of buildings to a communication network. The BPL transmission spectrum usually ranges from 2 to 30 MHz and thus overlaps the frequencies used by various radio services. This may lead to collision between these services and the BPL applications.

Accordingly, in practice, certain frequency ranges are omitted (notching). This method has been discussed for quite some time in the relevant EMV (electro-magnetic compatibility) committees. The frequencies of radio services to be protected are notched in the BPL signal in order to avoid collision and to ensure the coexistence of BPL and radio services.

In notching, generally two versions can be distinguished:
1. Static notching:
   Here, a frequency range is permanently notched in the BPL signal in order to protect particularly sensitive and/or safety-relevant services.
2. Dynamic notching:
   Here, frequency ranges are only notched in the BPL signal when a desired signal of a radio service is actually given.

Dynamic notching is presently only discussed for the frequencies of short wave radio because here the transmission of the service is subject to various physical phenomena which are hard to predict. Contrary to static notching of radio transmissions, dynamic notching can increase the useful BPL-frequency spectrum by approx. 20% in this environment.

However, the challenges here are the detection of a short wave signal “worth protecting” showing the required receiver strength for a commercial receiver.

2. Description of Related Art

One potential concept for detecting such signals is described in DE 603 12 839 T2. For this method, prior to the start of the PLC activity, the entire frequency spectrum potentially used by the PLC system is scanned and existing radio sources are detected. Alternatively or additionally it is described that gaps in the period or in the frequency band are used for detecting radio transmitters. Gaps in the period shall be understood as time without any PLC activity; gaps in the frequency band are frequency ranges not used for PLC communication. Additionally, particular correlation methods may be used for a further improvement of the detection mechanisms.

It is disadvantageous in the method according to DE 603 12 839 T2 that it can only be used when no PLC activity is given. This leads to the fact that the entire PLC system must be switched off or deactivated for detection. If a desired signal changes during operation of the system, it cannot be addressed here. This may be the case, for example, when a short wave transmitter due to atmospheric disturbances was received with only poor quality during detection.

### BRIEF SUMMARY

The present invention is therefore based on the objective to design and further develop a method of the type mentioned at the outset that allows detection of the frequencies that shall be notched in the PLC signal, and thus the notching parameters, even in an operating PLC system. A respective PLC system shall be provided.

The above-mentioned objective is attained in the features of claim 10. Accordingly, the method in question is characterized in that, at least for a section of the PLC signal, a desired signal-to-interference ratio is formed (SIR); that, depending on the SIR, the signal strength of a radio signal is assessed; and that, based on said assessment, notching parameters are determined or adjusted.

With regards to a PLC system, the above-described objective is attained in the features of claim 18. Accordingly, the PLC system in question is characterized in that the PLC system comprises a measuring unit to measure a signal-to-interference ratio (SIR) of a PLC signal; that the measuring unit is connected to an evaluation unit to assess the SIR measured; and that the configuration unit to determine or adjust notching parameters is connected to an evaluation unit based on the assessments of the evaluation unit.

### DETAILED DESCRIPTION OF VARIOUS EMBODIMENTS

According to the invention, it first has been recognized that, for determining notching parameters in a PLC system, a partial or even entire inactivity of the PLC system is not necessary. Rather it is possible to determine the presence of potentially interfering radio signals also during operation of said PLC system. For this purpose, according to the invention, the signal interference ratio (SIR) is determined. SIR is defined as the quotient between the average power received as a desired signal modulated on a carrier and the average interference power received via the same carrier and not originating in the desired signal. SIR is commonly used to describe the interference of different systems or partial components. According to the invention, SIR may also be used in the context of the determination of notching parameters. The desired data transmitted via the PLC signal are here referenced to the signals interspersed. This way, the power can be determined which does not originate in the PLC signal transmitting via the hub. These signal portions may originate in various sources. One option is the presence of a radio signal interfering with the PLC signal.

According to the invention, depending on the SIR, the signal strength is assessed originating in an interfering signal, usually a radio signal. Based on the assessment of the signal strength, notching parameters are determined. Again based on the notching parameters, notches can be implemented by which the PLC signal, after the activation of the notches in the area around the interfering radio signal, no longer shows no essential signal portions. This way, additional interference of the PLC signal via the radio signal can be avoided.

If a radio signal shall be detected close to an already set notch, the notching parameters of the respective notch can be adjusted such that the notch, after adjustment of said notching parameters, also covers the newly detected radio signal. Notching parameters may represent the central frequency, the width, or the slew rate of the notch. Frequently, the notches are implemented as digital filters.

After a notch has been placed, it can regularly be reviewed if any activity of the radio signal is still present in the frequency range notched by the PLC signal. If this is denied, in principle the notch can be deactivated and the frequency range be once more used by the PLC signal. Here, a certain period of inactivity of the radio signal may elapse before said notch is deactivated. The notching parameters allocated to said notch can, in principle, be deleted.

Preferably, a PLC receiver signal is used to determine the SIR, which is received at a hub of the PLC system. Accordingly, it is possible in a simple fashion to determine the SIR without particular measuring signals being required. Further, it shall be detected that any inactivity of the PLC system in this implementation is even undesired because, in the PLC system, data must be transmitted to the hub in order to determine the SIR and thus a foundation for assessing any potentially interfering radio signals.

According to one embodiment, the hub may also be formed by a hub in the access network. Parts of the network by which access is granted to the network of a provider are called access network. For example, data are transmitted via this network to the Internet or distant participants. The access network is usually distinguished from the local network of the user and ends at the side of the user at the transit station to the user. An implementation of the interference detection in the access network allows the central determination of the notching parameters in a larger network and thus influences the frequencies used by the PLC.

In another embodiment, the hub, used to determine the SIR via its PLC receiver signal, may be formed by a device of the end user. Here, for example, a BPL (broadband power line) modem may be used. In this case, too, PLC activity is desired in order to determine the SIR. An implementation of the determination of the SIR in a user device is advantageous, such that the determination of the notching parameters can essentially be performed more granularly. Thus, locally very different radio signals available can be detected and appropriately protected.

The two above-described embodiments can be combined arbitrarily. For example, a rough detection may be performed in the access network, with here higher signal power being required for evaluation. Then, via fine detection in a BPL modem, additional present radio signals which are weaker, but still with sufficient signal quality, can be filtered and protected. Other embodiments of potential combinations are possible and obvious for one trained in the art.

Preferably, it is determined by a method according to the invention if a radio signal shows sufficient signal strength in order to be received and processed in a commercial receiver for the respective radio signal. Here, a sensitive but still commercial receiver may be assumed. If the radio signal fails to show respective minimum field strength, the radio signal cannot be classified as useful and no notching parameters are determined. However, if the radio signal shows minimum field strength, respective notching parameters are determined and notches are implemented based on said notching parameters.

The radio signals may be generated by radio transmitters. In the frequency range used in presently common PLC systems, they are short wave radio transmitters. In addition to radio transmitters, it is also possible that the radio signal is formed by transmitters used for other radio services and not for the transmission of radio transmissions.

Preferably, a threshold fallen short by the SIR decides the presence of a radio signal that can be received. The falling short of a defined threshold states, assuming constant desired signal energy, that the interference, i.e. the power of the interspersed radio signal, has increased. The threshold can be defined relatively freely; however, it may be required to fulfill framework conditions set by standards or laws. In general, the threshold depends on the energy of the desired signal and the threshold defined for allowing a radio signal to be received. When such a defined threshold is fallen short by the SIR, here the presence of a receivable radio signal has been indicated subject to be protected respectively. The notching parameters required to protect the radio signal are determined or adjusted and a notch is implemented based on the notching parameters.

Due to the fact that a PLC signal is distributed over different sub-carriers, the SIR could be determined for a particular sub-carrier, particularly for improving measurements. This way, the signal energy transmitted on average in the sub-carrier may be referenced to the interference. This is advantageous, particularly for simplifying the calculation and granularity. Further, a notch may be implemented in a first approach, such that the respective sub-carrier is not used.

System-internal parameters of the BPL system may be used for assessing the SIR. For example, information is given at the receiver of a PLC signal regarding the quality of the desired signal, promoting the determination of the SIR.

In order to determine the SIR, it is necessary to determine the desired signal or at least the energy transmitted thereby. This may occur in various manners. For example, it is possible to determine the energy of the desired signal at the transmitter of the PLC signal and to appropriately transmit this information to the receiver of the PLC signal. The transmitted PLC signal then has to be converted using a channel model so that, for example, channel damping may be applied in the SIR.

Another option to generate a desired signal is to consider the symbol received with the desired signal. For this purpose, first the signal received is demodulated from the desired signal. Preferably, then an error detection and, if necessary, an error correction are performed. Information regarding flawed symbols may also be extracted from information at the respective receiver of the PLC signal. The received and perhaps error-corrected symbol would be modulated according to the modulation of the PLC-desired signal received. The desired signal, reconstructed in this manner, of the most probably desired signals transmitted by the transmitter of the PLC signal could be corrected according to the features of the transmission channel. For this purpose, information can be used which is already present for operating a PLC system, such as the damping of the transmission signal on the path to the receiver. A concrete implementation of such a system is described, for example, in DE 10 2010 051 710, which is hereby explicitly included by way of reference.

Summarizing, it can be stated that measurements are performed in the PLC signal by the method according to the invention and the PLC system according to the invention. The method is independent from modulation and access methods.

A particularly preferred embodiment of the invention is characterized in the BPL receiver signal being used to detect the signal strength of short wave—radio frequency “worth protecting”. The detection itself occurs by measuring and assessing the power ratio of desired signals in reference to interference signals in the BPL receiver signal

This may occur with or without the use of internal BPL system parameters.

The method may be implemented in all BPL chips/systems (in-house and access).

With regards to additional beneficial embodiments of the device according to the invention, reference is made to the general part of the description and the attached claims in order to avoid repetitions.

Finally, it shall explicitly be pointed out that the above-described exemplary embodiments of the device according to the invention exclusively serve to explain the claimed model, but without any restriction to these exemplary embodiments.

1-9. (canceled)

10. A method to determine one or more notching parameters for a PLC (Powerline Communication) signal in a PLC system, where, by way of notching, frequency ranges in the PLC signal are omitted in a targeted fashion and the notching parameters are selected, such that any interference of the PLC signal with a radio signal is largely avoided, wherein:
at least for one range of the PLC signal, a signal-to-interference ratio (SIR) is formed;
dependent on the formed SIR, a signal strength of a radio signal is assessed; and
based on the assessment, one or more notching parameters are determined or adjusted.

11. A method according to claim 10, wherein a PLC receiver signal is used to determine the SIR, with the PLC receiver signal being received at a hub of the PLC system.

12. A method according to claim 11, wherein PLC signals received in the access network in a hub are used as the PLC receiver signal.

13. A method according to claim 11, wherein the PLC signal received in the user device is used as the PLC receiver signal with the user device preferably representing a BPL modem.

14. A method according to claim 10, wherein, in case the SIR falls short of a defined threshold, the presence of a radio signal that can be received is indicated, and the notching parameters for protecting the radio signal required for a notch are determined or adjusted.

15. A method according to claim 10, wherein the SIR is determined for each sub-carrier of the PLC signal to be assessed.

16. A method according to claim 10, wherein system-internal parameters of the BPL system are used for assessing the SIR.

17. A method according to claim 10, wherein for the determination of a desired signal, the symbol received with the desired signal is demodulated, with at least one of an error detection and correction being performed for the symbol received and, based on the at least one of received and error-corrected symbol, the originally transmitted desired signal is reconstructed.

18. A PLC system with a configuration unit to determine notching parameters, with at least one hub of the PLC systems being influenced by the notching parameters, such that frequency ranges are notched in a targeted fashion in the PLC signal transmitted by the hub in order to avoid interference of the PLC signal transmitted by the hub with a radio signal, particularly to perform a method according to claim 10, wherein the PLC system comprises a measuring unit to measure a signal interference ratio (SIR) of a PLC signal, that the measuring unit is connected to an evaluation unit to assess the measured SIRs, and that the configuration unit is connected to the evaluation unit in order to determine or adjust notching parameters based on the assessment of the evaluation unit.
